(19) United States
(12) Patent Application Publication
(10) Pub. No.: US 2023/0404852 A1
(43) Pub. Date: Dec. 21, 2023

(54) Vial Adapter with Air Management Device

(71) Applicant: Becton, Dickinson and Company, Franklin Lakes, NJ (US)

(72) Inventor: Paul Paia Marici, Piscataway, NJ (US)

(21) Appl. No.: 18/036,001

(22) PCT Filed: Nov. 9, 2021
(86) PCT No.: PCT/US21/58540

§ 371 Date: May 9, 2023

Related U.S. Application Data
(60) Provisional application No. 63/111,681, filed on Nov. 10, 2020.

(51) Int. Cl. A61J 1/20

(52) U.S. Cl. CPC A61J 1/2072; A61J 1/2096; A61J 1/201; A61J 1/2086

(57) ABSTRACT

A vial adapter includes a body having a component connection interface and a vial connection interface, a pressure equalization assembly including an equalization housing, an expandable member, and a valve member, with the equalization housing and the expandable member defining a space configured to expand from a first volume to a second volume larger than the first volume, and a piercing member. The equalization housing defining an equalization opening in fluid communication with the space and an intake opening in fluid communication with the valve member, with the valve member configured to allow air into the space from the intake opening and prevent air from the space to exit the intake opening. The equalization housing defines a channel in fluid communication with the equalization opening and the valve member.

### CROSS-REFERENCE TO RELATED APPLICATION

The present application claims priority to U.S. Provisional Application Ser. No. 63/111,681, entitled “Vial Adapter with Air Management Device”, filed Nov. 10, 2020, the entire disclosure of which is hereby incorporated by reference in its entirety.

### BACKGROUND OF THE INVENTION

### Field of the Invention

The present invention relates to a vial adapter with an air management device

### Description of Related Art

Health care providers reconstituting, transporting, and administering hazardous drugs, such as chemotherapeutic medication, can put health care providers at risk of exposure to these medications and present a hazard in the health care environment. Unintentional chemotherapy exposure can affect the nervous system, impair the reproductive system, and bring an increased risk of developing blood cancers in the future. Some drugs must be dissolved or diluted before they are administered, which involves transferring a solvent from one container to a sealed vial containing the drug in powder or liquid form. Drugs may be inadvertently released into the atmosphere in gas form or by way of aerosolization, during the withdrawal of the medication from the vial if any pressure differential between the interior of the vial and the surrounding atmosphere exists. In order to reduce the risk of health care providers being exposed to toxic drugs, the transfer of these drugs is accomplished utilizing a closed system transfer device or system.

Vial adapters for accessing the vial or container utilize a piercing member that penetrates the sealing member of the container and defines an opening at a distal end of the piercing member. Typically, after the piercing member accesses the vial, the vial is inverted to withdraw the medicament from the container. Such devices may also include a pressure equalization arrangement to prevent pressurization of the container or a vacuum being created within the container, which can deform the container and increase the risk of the medication entering the surrounding environment. Prior to withdrawing liquid medication from the container, a syringe, which may be attached to a syringe adapter, is filled with air by pulling back on the plunger of the syringe. The air within the syringe is pushed into the container via the vial adapter, which expands the pressure equalization arrangement. The liquid medication is then withdrawn with the air in the pressure equalization arrangement replacing the fluid within the container to maintain a pressure within the container. If the air is not supplied to the container prior to withdrawing the liquid medication, a vacuum may be created within the vial and withdrawal of the liquid medication may be inhibited and/or cause a portion of the medication to infiltrate the pressure equalization arrangement. Medication within the pressure equalization arrangement is undesirable and may result in the loss of a portion of the medication.

### SUMMARY OF THE INVENTION

In one aspect or embodiment, a vial adapter includes a body having a component connection interface and a vial connection interface, with the component connection interface configured to engage a connection interface of a mating component, a pressure equalization assembly comprising an equalization housing, an expandable member, a valve member, and a piercing member. The equalization housing and the expandable member define a space configured to expand from a first volume to a second volume larger than the first volume, with the equalization housing defining an equalization opening in fluid communication with the space and an intake opening in fluid communication with the valve member. The valve member is configured to allow air into the space from the intake opening and prevent air from the space to exit the intake opening. The equalization housing defines a channel in fluid communication with the equalization opening and the valve member. The piercing member has a first end connected to the body and a second end positioned opposite the first end, with the piercing member and the body defining a fluid passageway and a pressure equalization passageway. The fluid passageway is in fluid communication with the component connection interface and the pressure equalization passageway is in fluid communication with the equalization opening of the pressure equalization assembly.

The expandable member may be a film configured to move from a first position where the film is positioned within the equalization housing and a second position where at least a portion of the film is positioned outside of the equalization housing. The channel may be configured to provide fluid communication between the intake opening and the equalization opening when the film is in the first position. The equalization opening may be a plurality of equalization openings arranged in a circle, with the channel including an annular portion in fluid communication with the plurality of equalization openings and a linear portion extending from the annular portion to the valve member.

The valve member may be a one-way valve. The intake opening may be a plurality of intake openings. The valve member may include a diaphragm and a stem, with the stem attached to the equalization housing via a valve opening and the valve member having a first position where the diaphragm seals the plurality of intake openings from the space and a second position where the diaphragm unseals the plurality of intake openings from the space.

The vial adapter may include a filter positioned between the pressure equalization passageway and the equalization opening. The filter may include a hydrophobic filter. The filter may be configured to filter out particles with a diameter larger than 0.45 μm.

The component connection interface may include a membrane and may be configured to mate with a syringe adapter. The vial connection interface may be configured to secure the vial adapter to a container. The body and the equalization housing may be formed separately.

### BRIEF DESCRIPTION OF THE DRAWINGS

FIG. 1 is a perspective view of a vial adapter according to one aspect or embodiment of the present application, showing the vial adapter attached to a vial.

FIG. 2A is a cross-sectional view of the vial adapter of FIG. 1, showing a first position of an expandable member.

FIG. 2B is a cross-sectional view of the vial adapter of FIG. 1, showing a second position of an expandable member.

FIG. 3 is a front perspective view of a portion of the vial adapter of FIG. 1.

FIG. 4 is a rear perspective view of a portion of the vial adapter of FIG. 1.

FIG. 5 is a top perspective view of a valve member according to one aspect or embodiment of the present application.

FIG. 6 is a bottom perspective view of the valve member of FIG. 5

FIG. 7 is a partial cross-sectional view of the vial adapter of FIG. 1.

### DETAILED DESCRIPTION

For purposes of the description hereinafter, the terms such as “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. Further, it is to be understood that the invention may assume various alternative variations and step sequences, except where expressly specified to the contrary.

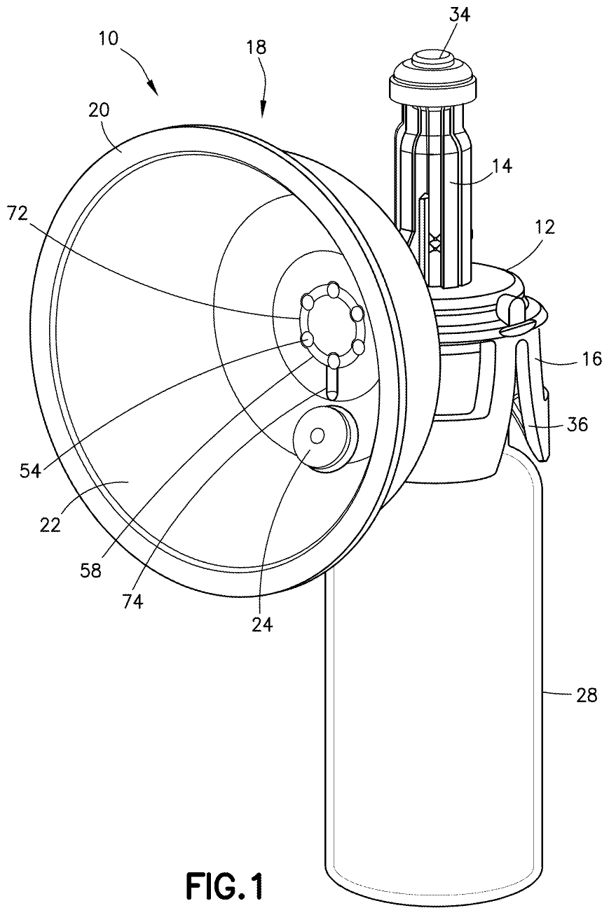

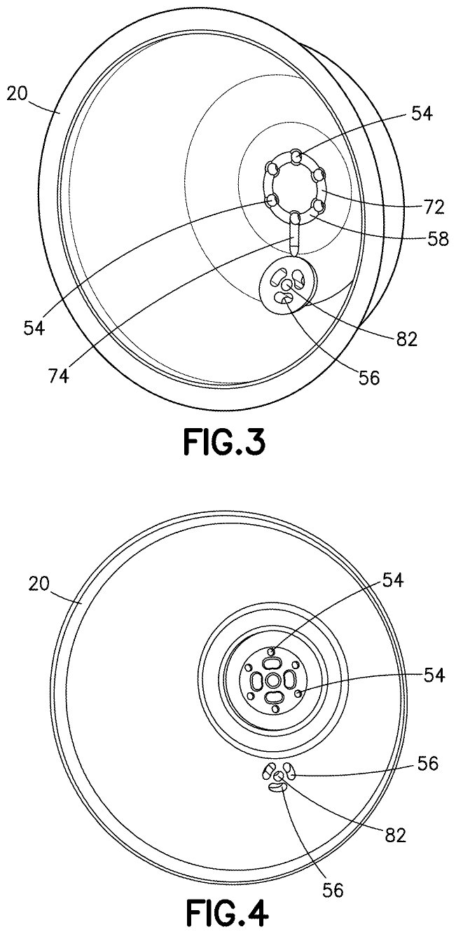

Referring to FIGS. 1-7, according to one aspect or embodiment, a vial adapter 10 includes a body 12 having a component connection interface 14 and a vial connection interface 16, a pressure equalization assembly 18 having an equalization housing 20, an expandable member 22, a valve member 24, and a piercing member 26. The vial adapter 10 is a closed system transfer device component and utilized to facilitate transfer of medication from a container 28, such as a vial, to another container or component, such as a syringe connected to a syringe adapter (not shown), while preventing release of medication within the container 28 to the surrounding environment.

Referring to FIGS. 1-4, the component connection interface 14 is configured to engage a connection interface of a mating component. In one aspect or embodiment, the component connection interface 14 includes a membrane 34 and is configured to mate with a syringe adapter. The component connection interface 14 may be the same and operate in the same manner as the connection interface shown in FIGS. 20 and 21 of U.S. Patent Application Publication No. 2018/0200147, the disclosure of which is incorporated by reference herein. The vial connection interface 16 is configured to secure the vial adapter 10 to the container 28. The vial connection interface 16 includes a plurality of resilient arms 36 having protrusions 38 that engage the rim of the container 28 when the piercing member 26 has been pushed through a sealing member 40 of the container 28, although other suitable arrangements for the vial connection interface 16 may be utilized. The size of the vial adapter 10 and the vial connection interface 16 may vary depending the size of the container or vial 28. In one aspect or embodiment, the vial adapter 10 has a specific size and dimensions for each vial size, such as a 13 mm vial, 20 mm vial, 28 mm vial, 32 mm vial, etc. The resilient arms 36 deflect radially outward when the vial adapter 10 is in the process of being attached to the container 28 and return to their original position after being fully secured to the container 28.

Referring again to FIGS. 1-4, the equalization housing 20 and the expandable member 22 define a space 52 configured to expand from a first volume to a second volume larger than the first volume. The equalization housing 20 defines an equalization opening 54 in fluid communication with the space 52 and an intake opening 56 in fluid communication with the valve member 24. The equalization housing 54 and the body 12 are formed separately and secured to each other, although other suitable arrangements may be utilized. The valve member 24 is configured to allow air into the space 52 from the intake opening 56 and prevent air from the space 52 to exit the intake opening 56. The equalization housing 20 defines a channel 58 in fluid communication with the equalization opening 54 and the valve member 24. The piercing member 26 has a first end 62 connected to the body 12 and a second end 64 positioned opposite the first end 62. The piercing member 26 and the body 12 define a fluid passageway 66 and a pressure equalization passageway 68. The fluid passageway 66 is in fluid communication with the component connection interface 14 and the pressure equalization passageway 68 is in fluid communication with the equalization opening 54 of the pressure equalization assembly 18. In one aspect or embodiment, at least a portion of the piercing member 26 is covered by a retractable sleeve (not shown). The retractable sleeve may be the same as the retractable sleeve shown and described in U.S. Pat. No. 9,919,826, incorporated by reference herein.

The pressure equalization assembly 18 is configured to equalize the pressure within the container 28 during fluid transfer by the use of the pressure equalization passageway 68, the equalization opening 54, and the expandable member 22. The pressure equalization passageway 68 is in fluid communication with the space 52 such that air or fluid introduced into the container 28 using the vial adapter 10 will displace the air within the container 28 and expand the expandable member 22 from the first volume to the second volume. In particular, during use of the vial adapter 10, the pressure equalization assembly 18 is utilized to regulate the pressure within the container 28 and contain the medication and any vapor thereof within the vial adapter 10 and within the container 28.

When the vial adapter 10 is attached to the container 28, the intake opening 56 of the pressure equalization assembly 18 allows fluid to be withdrawn from the container 28 via a syringe and syringe adapter (not shown) without first injecting air into the container 28 to expand the expandable member 22. When the plunger of the syringe is withdrawn to draw fluid from the container 28, air is allowed to enter the space 52 via the intake opening 56, past the valve member 24, through the channel 58, through the equalization opening 54, through the pressure equalization passageway 68, and into the container 28 to replace the withdrawn fluid such that a vacuum is not created within the container 28. The valve member 24, however, prevents the flow of air or vapor from the space 52 through the intake opening 56 to ensure the medication and any vapor are contained within the vial adapter 10 and the container 28.

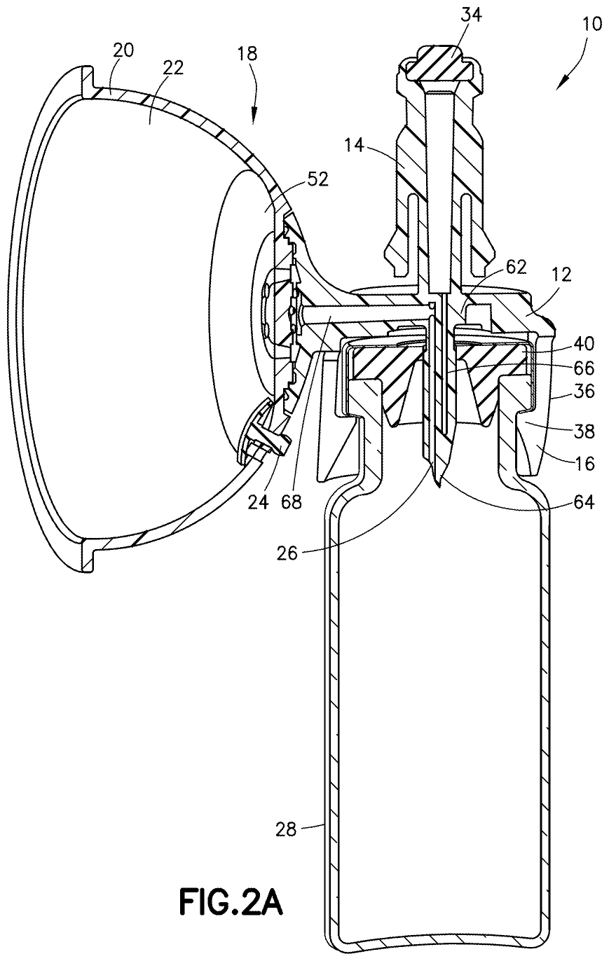

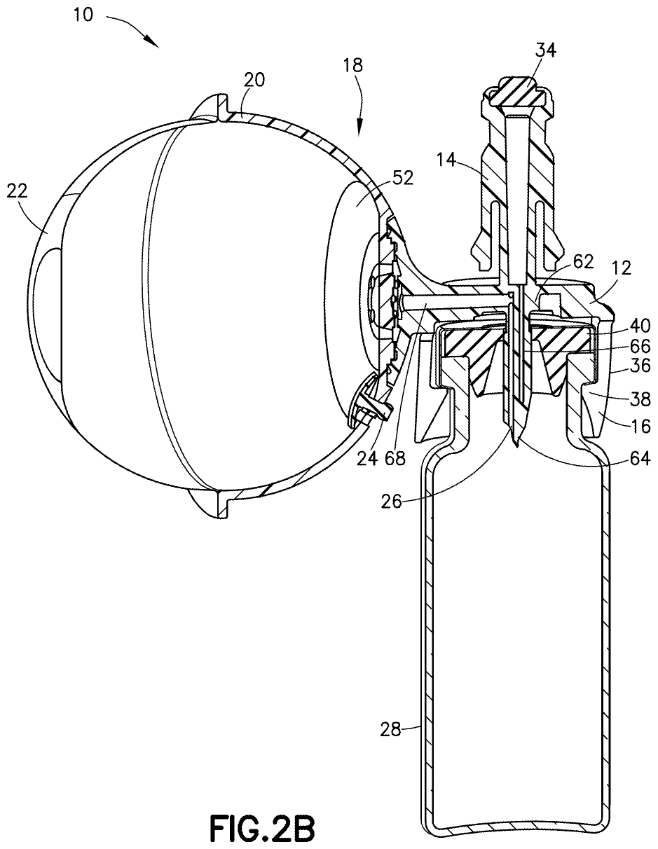

Referring to FIGS. 1-3, in one aspect or embodiment, the expandable member 22 is a film configured to move from a first position where the film is positioned within the equalization housing 20 (shown in FIG. 2A) and a second position where at least a portion of the film is positioned outside of the equalization housing 20 (shown in FIG. 2B), although other suitable expandable members may be utilized. The channel 58 is configured to provide fluid communication between the intake opening 56 and the equalization opening 54 when the film is in the first position. When in the first position, the film may be flush with the equalization housing 20 within the space 52 such that, without the channel 58, the film would block fluid communication between the intake opening 56 and the equalization opening 54. In one aspect or embodiment, the equalization opening 54 is a plurality of equalization openings arranged in a circle, with the channel 58 including an annular portion 72 in fluid communication with the plurality of equalization openings 54 and a linear portion 74 extending, from the annular portion 72 to the valve member 24.

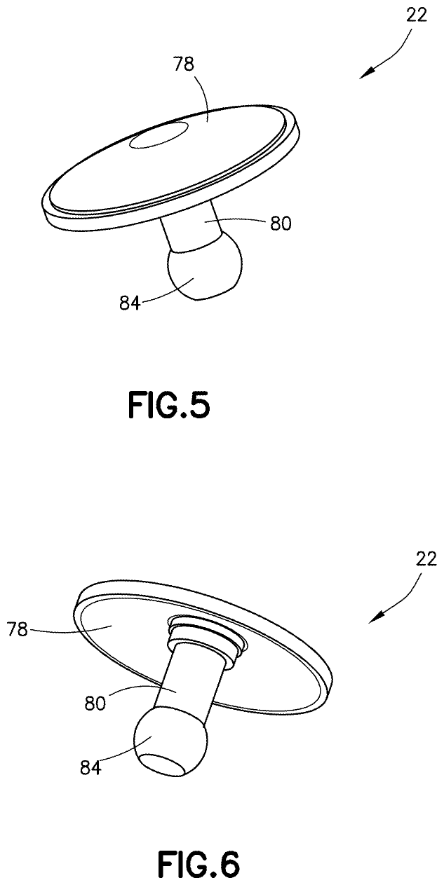

Referring again to FIGS. 1-7, the valve member 24 may be a one-way valve. In one aspect or embodiment, the valve member 24 is an umbrella valve, although other suitable arrangements may be utilized. The intake opening 56 may be a plurality of intake openings. As shown more clearly in FIGS. 5 and 6, the valve member 24 includes a diaphragm 78 and a stem 80. The stem 80 is attached to the equalization housing 20 via a valve opening 82. The stem 80 includes a projection 84 to secure the valve member 24 to the equalization housing 20, although other suitable arrangements may be utilized. The valve member 24 has a first position where the diaphragm 78 seals the plurality of intake openings 56 from the space 52 and a second position where the diaphragm 78 unseals the plurality of intake openings 56 from the space 52. When air or fluid is aspirated from the container 28, the corresponding pressure drop within the space 52 causes the diaphragm 78 to lift upwards thereby allowing air to flow through the intake openings 56, past the diaphragm 78, through the channel 58, through the equalization openings 54, through the pressure equalization passageway 68, and into the container 28. The diaphragm 78 returns to an original, unbiased position to seal the intake openings 56 when the syringe is no longer drawing fluid from the container 28. Any pressure increase inside the space 52 applies pressure to the top of the diaphragm 78 and ensures the diaphragm 78 seals the intake openings 56.

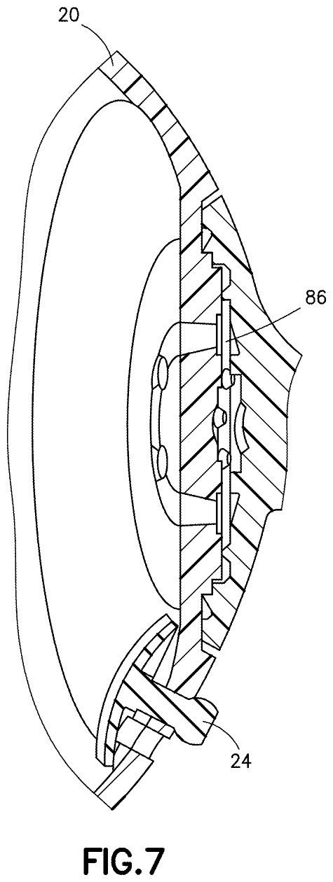

Referring to FIGS. 2A, 2B, and 7, in one aspect or embodiment, the vial adapter 10 further includes a filter 86 positioned between the pressure equalization passageway 68 and the equalization opening 54. The filter 86 may be a hydrophobic filter. In one aspect or embodiment, the filter 86 is configured to filter out particles with a diameter of 0.45 μm. The filter 86 is configured to prevent medication or fluid from entering the space 52 of the pressure equalization assembly 18. During the withdrawal of medication from the container 28, the filter 86 is configured to filter the air from the intake opening 56 before the air enters the pressure equalization passageway 68 and the container 28. Thus, the valve member 24 is configured to allow filtered air, which passes through the filter 86, into the medication space or container 28 from the intake opening 56 and prevent contaminated air from the space 52 to exit the intake opening 56.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims. To the extent possible, one or more features of any aspect or embodiment discussed above can be combined with one or more features of any other aspect or embodiment.

1. A vial adapter comprising:
a body having a component connection interface and a vial connection interface, the component connection interface configured to engage a connection interface of a mating component;
a pressure equalization assembly comprising an equalization housing, an expandable member, and a valve member, the equalization housing and the expandable member defining a space configured to expand from a first volume to a second volume larger than the first volume, the equalization housing defining an equalization opening in fluid communication with the space and an intake opening in fluid communication with the valve member, the valve member is configured to allow air into the space from the intake opening and prevent air from the space to exit the intake opening, the equalization housing defining a channel in fluid communication with the equalization opening and the valve member; and
a piercing member having a first end connected to the body and a second end positioned opposite the first end, the piercing member and the body defining a fluid passageway and a pressure equalization passageway, the fluid passageway is in fluid communication with the component connection interface, the pressure equalization passageway is in fluid communication with the equalization opening of the pressure equalization assembly.

2. The vial adapter of claim 1, wherein the expandable member comprises a film configured to move from a first position where the film is positioned within equalization housing and a second position where at least a portion of the film is positioned outside of the equalization housing.

3. The vial adapter of claim 2, wherein the channel is configured is provide fluid communication between the intake opening and the equalization opening when the film is in the first position.

4. The vial adapter of claim 1, wherein the equalization opening comprises a plurality of equalization openings arranged in a circle, the channel comprising an annular portion in fluid communication with the plurality of equalization openings and a linear portion extending from the annular portion to the valve member.

5. The vial adapter of claim 1, wherein the valve member comprises a one-way valve, and wherein the intake opening comprises a plurality of intake openings.

6. The vial adapter of claim 5, wherein the valve member comprises a diaphragm and a stem, the stem is attached to the equalization housing via a valve opening, the valve member having a first position where the diaphragm seals the plurality of intake openings from the space and a second position where the diaphragm unseals the plurality of intake openings from the space.

7. The vial adapter of claim 1, further comprising a filter positioned between the pressure equalization passageway and the equalization opening.

8. The vial adapter of claim 7, wherein the filter comprises a hydrophobic filter.

9. The vial adapter of claim 7, wherein the filter is configured to filter out particles with a diameter larger than 0.45 μm.

10. The vial adapter of claim 1, wherein the component connection interface comprises a membrane and is configured to mate with a syringe adapter.

11. The vial adapter of claim 1, wherein the vial connection interface is configured to secure the vial adapter to a container.

12. The vial adapter of claim 1, wherein the body and the equalization housing are formed separately.
